(19) United States
(12) Patent Application Publication
(10) Pub. No.: US 2022/0244621 A1
(43) Pub. Date: Aug. 4, 2022

(54) OPTICAL UNIT

(71) Applicant: NIDEC SANKYO CORPORATION, Nagano (JP)

(72) Inventor: Takeshi SUE, Nagano (JP)

(21) Appl. No.: 17/630,505

(22) PCT Filed: Jul. 29, 2020
(86) PCT No.: PCT/JP2020/029059

§ 371 Date: Jan. 27, 2022

(30) Foreign Application Priority Data
Aug. 1, 2019 (JP) 2019-142329

(51) Int. Cl. G03B 17/17; G03B 5/00

(52) U.S. Cl. CPC G03B 17/17; G03B 2205/0069; G03B 5/00

(57) ABSTRACT

An optical unit includes a substrate including an imaging element that captures a subject image by an incident light flux; a reflector that reflects the incident light flux from an incident direction on outside in a reflection direction toward the imaging element; a substrate pivoting mechanism including a set of a first magnet and a first coil that pivots the substrate with reference to a rolling axis Ar; and a reflector pivoting mechanism including a set of a second magnet and a second coil that pivots the reflector with reference to at least one of a yawing axis Ay and a pitching axis Ap.

### RELATED APPLICATIONS

The present application is a National Phase of International Application Number PCT/JP2020/029059, filed Jul. 29, 2020, and claims priority based on Japanese Patent Application No. 2019-142329, filed Aug. 1, 2019.

### TECHNICAL FIELD

At least an embodiment of the present invention relates to an optical unit.

### BACKGROUND ART

Conventionally, various optical units have been used that are equipped with substrates including imaging elements that capture images of subject by incident light fluxes and reflectors that reflect the incident light fluxes. Through a configuration in which an incident light flux is reflected, the optical unit can be made thinner. For example, Patent Literature 1 discloses a camera module including a substrate including an image sensor and a prism for reflecting an incident light flux.

### CITATION LIST

### Patent Literature

[Patent Literature 1] US2018/0217475A1

### SUMMARY OF THE INVENTION

### Problems to be Solved by the Invention

However, a conventional optical unit, such as that described above, including a substrate including an imaging element and a reflector does not have a configuration that allow adjustment of the incident light flux toward the imaging element in a wide adjustment range. For example, in the camera module of Patent Literature 1, there is a risk that the incident light flux may be shifted in the rotation direction and be incident on the imaging element. Therefore, it is an object of at least an embodiment of the present invention to provide an optical unit that is thin and allows a wide adjustment range of an incident light flux toward an imaging element.

### Means for Solving the Problem

An optical unit of the present invention includes a substrate including an imaging element that captures a subject image by an incident light flux; a reflector that reflects the incident light flux from an incident direction from outside in a reflection direction toward the imaging element; a substrate pivoting mechanism including a set of a first magnet and a first coil and pivoting the substrate with reference to a rolling axis; and a reflector pivoting mechanism including a set of a second magnet and a second coil and pivoting the reflector with reference to at least one of a yawing axis and a pitching axis.

According to this aspect, provided is a reflector pivoting mechanism that pivots a reflector with reference to at least one of the yawing axis and the pitching axis, and a substrate pivoting mechanism that pivots the substrate with reference to the rolling axis. Therefore, the reflector can be moved in a wide range, and the risk of the incident light flux being shifted in the rotation direction and incident on the imaging element can be eliminated by pivoting the substrate with reference to the rolling axis. That is, the optical unit can made to allow adjustment of the incident light flux toward the imaging element within a wide adjustment range. Moreover, since the reflector is provided, the optical unit can be made thinner Furthermore, since the substrate pivoting mechanism and the reflector pivoting mechanism each consist of a set of a magnet and a coil, the substrate pivoting mechanism and the reflector pivoting mechanism can be downsized, and, in particular, the optical unit can be made thinner.

It is preferred that in the optical unit of the present invention, the reflector pivoting mechanism pivot the reflector with reference to both the yawing axis and the pitching axis. This is because pivoting the reflector with reference to both the yawing axis and the pitching axis allows the reflector to move in a particularly wide range.

In a preferred example of the optical unit of the present invention, the set of the second magnet and the second coil pivoting the reflector with reference to the yawing axis is provided as the reflector pivoting mechanism at a position overlapping the reflector as viewed from the incident direction. This is because the balance of the reflector with reference to the yawing axis becomes better.

In a preferred example of the optical unit of the present invention, the set of the second magnet and the second coil pivoting the reflector with reference to the yawing axis is provided as the reflector pivoting mechanism at a position overlapping the reflector as viewed from the pitching axis direction. This is effective when there is no space to position the reflector pivoting mechanism in a manner overlapping the reflector as viewed from the incident direction.

With such a configuration, it is preferred that sets of the second magnet and the second coil serving as the reflector pivoting mechanism to pivot the reflector with reference to the yawing axis be disposed on both sides of the reflector along the pitching axis direction as viewed from the incident direction. This is because the balance of the reflector with reference to the yawing axis becomes better.

It is preferred that in the optical unit of the present invention, sets of the first magnet and the first coil serving as the substrate pivoting mechanism be disposed on both sides of a rolling axis as viewed from the reflection direction. This is because the balance of the substrate with reference to the rolling axis becomes better.

It is preferred that in the optical unit of the present invention, the substrate pivoting mechanism include a set of the first magnet and the first coil, the first magnet being fixed to the substrate, the first coil being fixed on the periphery of the substrate at a position opposite the first magnet. This is because, by disposing the magnets on the substrate the pivoting unit including the substrate can be made smaller and the wiring can be facilitated.

It is preferred that in the optical unit of the present invention, the reflector pivoting mechanism include a set of the second magnet and the second coil, the second magnet being fixed to the reflector, the second coil being fixed on the periphery of the reflector at a position opposite the second magnet. This is because, by disposing the magnets on the reflector the pivoting unit including the reflector can be made smaller and the wiring can be facilitated.

It is preferred that the optical unit of the present invention further includes a lens unit disposed between the substrate and the reflector, and the lens unit be fixed to the substrate. This is because by fixing the lens unit to the substrate, the substrate can be pivoted while the positional relationship between the lens unit and the substrate is maintained.

### Effect of the Invention

The optical unit of at least an embodiment of the present invention is thin and allows a wide adjustment range of the incident light flux toward the imaging element.

### BRIEF DESCRIPTION OF THE DRAWINGS

FIG. 1 is a perspective view of a smartphone including an optical unit according to a first embodiment of the present invention.

FIG. 2 is a side view of the optical unit according to the first embodiment of the present invention.

FIG. 3 is a perspective view of the optical unit according to the first embodiment of the present invention.

FIG. 4 is a perspective view of the optical unit according to the first embodiment of the present invention viewed from an angle different from that in FIG. 2.

FIG. 5 is a perspective view of an optical unit according to a second embodiment of the present invention.

FIG. 6 is a perspective view of the optical unit according to the second embodiment of the present invention viewed from an angle different from that in FIG. 5.

### MODE FOR CARRYING OUT THE INVENTION

Embodiments of the present invention will now be described with reference to the drawings. Note that the same reference numerals are given to the same components in each of the embodiments, and these components will only be described in an embodiment where they first appear, and their description will be omitted in the following embodiments.

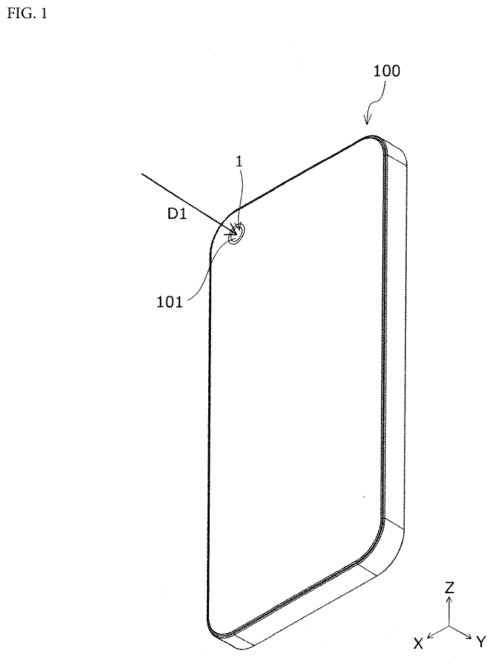

### First Embodiment (FIGS. 1 to 4)

First, an optical unit 1 according to a first embodiment of the present invention will be described with reference to FIGS. 1 to 4. In each drawing, the Y-axis direction corresponds to the incident direction D1 in which the incident light flux enters from the outside; the Z-axis direction corresponds to the direction orthogonal to the Y-axis direction and the reflection direction D2 in which the incident light flux is reflected by a mirror 21 of a reflector 2 toward an imaging element 41 disposed on a substrate 4; and the X-axis direction is a direction orthogonal to the Y-axis direction and the Z-axis direction. The rolling axis direction of the substrate 4 and the yawing axis direction of the reflector 2 correspond to the Z-axis direction, and the pitching axis direction of the reflector 2 corresponds to the X-axis direction.

Outline of Device Including Optical Unit

FIG. 1 is a schematic perspective view of a smartphone 100 as an example of a device including an optical unit 1 of an embodiment. The optical unit 1 of the present embodiment can be suitably used in the smartphone 100. This is because the optical unit 1 of the present embodiment can be thin and thereby reduce the thickness of the smartphone 100 in the Y-axis direction. However, the optical unit 1 of the present embodiment is not limited to the smartphone 100, and can be used in various devices, such as cameras and videos, without limitation.

As illustrated in FIG. 1, the smartphone 100 includes a lens 101 on which a light flux is incident. The optical unit 1 is disposed inside the lens 101 of the smartphone 100. The smartphone 100 allows the light flux to enter from the outside through the lens 101 in the incident direction D1 and is able to capture a subject image based on the incident light flux.

Overall Configuration of Optical Unit

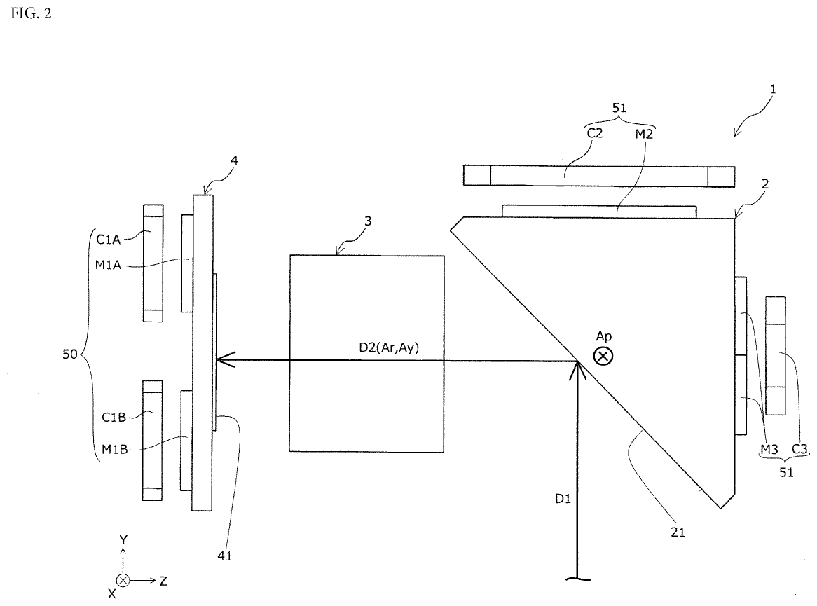

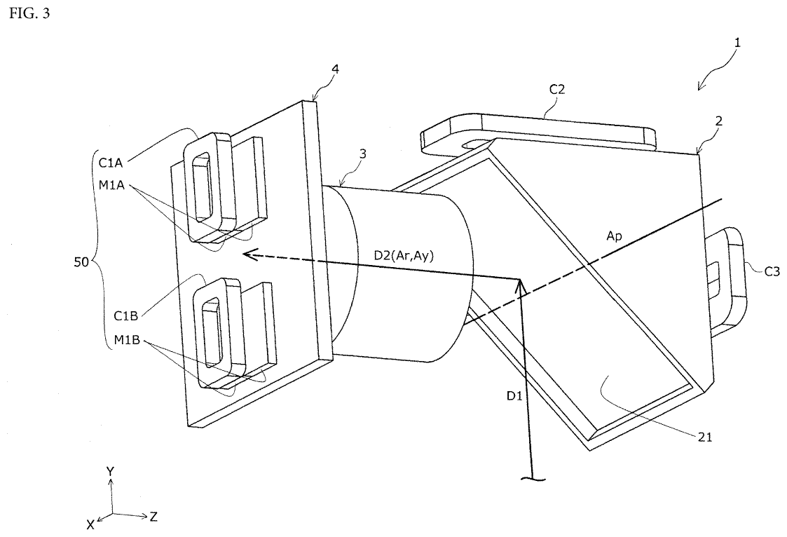

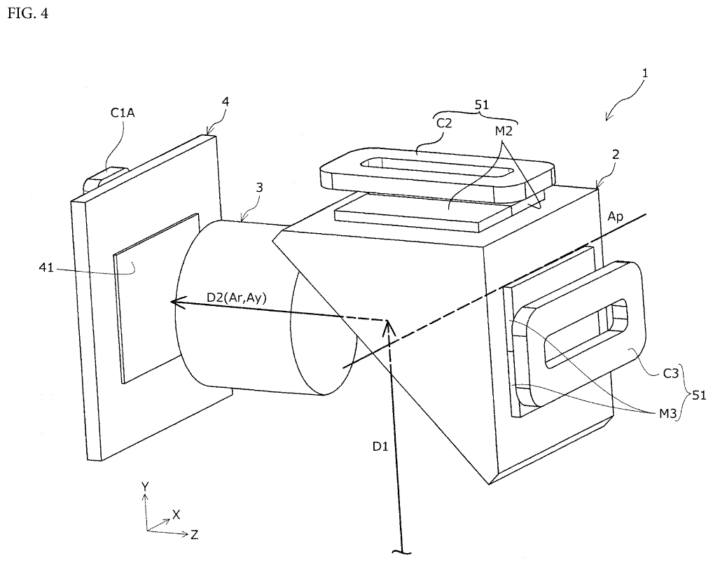

FIG. 2 is a side view that schematically illustrates the optical unit 1 of the present embodiment. FIGS. 3 and 4 are perspective views that schematically illustrate the optical unit 1 of the present embodiment, each of which is viewed from a different angle.

As illustrated in FIGS. 2 to 4, the optical unit 1 of the present embodiment includes a reflector 2, a lens unit 3, and a substrate 4. As illustrated in FIG. 2, the light flux incident from the outside through the lens 101 in the incident direction D1 (Y-axis direction) is reflected in the reflection direction D2 (Z-axis direction) by being reflected by the mirror 21 of the reflector 2, and reaches the imaging element 41 of the substrate 4 through the lens unit 3.

As illustrated in FIG. 3, the mirror 21 is disposed in the reflector 2, and the mirror 21 reflects the light flux incident in the incident direction D1 in the reflection direction D2. In other words, the reflector 2 reflects, by the mirror 21, the incident light flux from the incident direction D1 on the outside in the reflection direction D2 toward the imaging element 41. However, the configuration of the reflector 2 is not limited to the configuration in which the light flux is reflected by the mirror 21, but may also include the configuration in which the light flux incident in the incident direction D1 is reflected in the reflection direction D2 by a prism or the like that can change the emission direction of the incident light flux.

As illustrated in FIG. 2, etc., a magnet M2 is formed at a position overlapping the mirror 21 in the incident direction D1 in the reflector 2, and a coil C2 is formed at a position opposite the magnet M2. Here, the magnet M2 is fixed to the reflector 2 so that the N-pole and S-pole are aligned in the X-axis direction, and the coil C2 is fixed to a casing (not illustrated) around the reflector 2. Note that the reflector 2 is pivotable relative to the casing with reference to the yawing axis Ay along the Z-axis direction and the pitching axis Ap along the X-axis direction by a gimbal structure or the like. With such a configuration, the reflector 2 is pivotable relative to the casing with reference to the yawing axis Ay along the Z-axis direction by supplying an electrical current to the coil C2.

As illustrated in FIGS. 2 and 4, a magnet M3 is formed at a position overlapping the mirror 21 in the reflection direction D2 in the reflector 2, and a coil C3 is formed at a position opposite the magnet M3. Here, the magnet M3 is fixed to the reflector 2 so that the N-pole and S-pole are aligned in the Y-axis direction, and the coil C3 is fixed to the casing (not illustrated) around the reflector 2. With such a configuration, the reflector 2 pivots relative to the casing with reference to the pitching axis Ap along the X-axis direction by supplying an electrical current to the coil C3. Not that a set of the magnet M2 and the coil C2 and a set of the magnet M3 and the coil C3 constitute a reflector pivoting mechanism 51.

The lens unit 3 is formed by arraying a plurality of lenses along the reflection direction D2 (Z-axis direction). The configuration of the lens unit 3 is not particularly limited, and conventionally used lens units and the like can be used without particular limitation.

As illustrated in FIGS. 2 and 4, the substrate 4 is provided with the imaging element 41 that captures an image of a subject by an incident light flux. The light flux reflected by the mirror 21 reaches the imaging element 41 through the lens unit 3. As illustrated in FIG. 3, etc., a magnet M1A and a magnet M1B are formed on the substrate 4 remote from the imaging element 41; a coil C1A is formed at a position opposite the magnet M1A; and a coil C1B is formed at a position opposite the magnet M1B. Here, the magnet M1A and the magnet M1B are both fixed to the substrate 4 so that the N-pole and S-pole are aligned in the X-axis direction, and the coil C1A and the coil C1B are both fixed to the casing (not illustrated) around the substrate 4. The substrate 4 is pivotable relative to the casing with reference to the rolling axis Ar along the Z-axis direction. With such a configuration, the substrate 4 pivots relative to the casing with reference to the rolling axis Ar by supplying an electrical current to the coil C1A and the coil C1B. Note that a set of the magnet M1A and the coil C1A and a set of the magnet M1B and the coil C1B constitute a substrate pivoting mechanism 50.

In this way, the optical unit 1 of the present embodiment includes a substrate pivoting mechanism 50 that includes sets of a first magnet and a first coil (a set of the magnet M1A and the coil C1A and a set of the magnets M1B and the coil C1B) and pivots the substrate 4 with reference to the rolling axis Ar. The optical unit 1 also includes a reflector pivoting mechanism 51 that includes sets of a second magnet and a second coil (a set of the magnet M2 and the coil C2 and a set of the magnet M3 and the coil C3) and pivots the reflector 2 with reference to the yawing axis Ay and the pitching axis Ap. Since the optical unit 1 includes the reflector pivoting mechanism 51 that pivots the reflector 2 with reference to at least one of the yawing axis Ay and the pitching axis Ap and the substrate pivoting mechanism 50 that pivots the substrate 4 with reference to the rolling axis Ar, the reflector 2 can be moved within a wide range, and the substrate 4 can be pivoted with reference to the rolling axis Ar to eliminate the risk of the incident light flux being shifted in the rotation direction and being incident on the imaging element 41. That is, the optical unit 1 can made to allow adjustment of the incident light flux toward the imaging element 41 within a wide adjustment range. Moreover, since the reflector 2 is provided, the optical unit 1 can be made thinner Furthermore, since the substrate pivoting mechanism 50 and the reflector pivoting mechanism 51 each consist of a set of a magnet and a coil, the substrate pivoting mechanism 50 and the reflector pivoting mechanism 51 can be downsized, and, in particular, the optical unit 1 can be made thinner.

In particular, as in the optical unit 1 of the present embodiment, it is preferred that the reflector pivoting mechanism 51 pivots the reflector 2 with reference to both the yawing axis Ay and the pitching axis Ap. This is because pivoting the reflector 2 with reference to both the yawing axis Ay and the pitching axis Ap allows the reflector 2 to move in a particularly wide range.

The position of the formation of the set of the magnet M2 and the coil C2 that pivots the reflector 2 with reference to the yawing axis Ay is not particularly limited, but in a preferred embodiment, such as the optical unit 1 of the present embodiment, the set of the magnet M2 and the coil C2 are provided as the reflector pivoting mechanism 51 that pivots the reflector 2 with reference to the yawing axis Ay at a position overlapping the reflector 2 as viewed from the incident direction D1. This is because the balance of the reflector 2 with reference to the yawing axis Ay becomes better.

In the optical unit 1 of the present embodiment, the set of the magnet M1A and the coil C1A is disposed on one side (top side in FIG. 2) of the substrate 4 in the Y-axis direction, and the set of the magnet M1B and the coil C1B is disposed on the other side (bottom side in FIG. 2) of the substrate 4 in the Y-axis direction. The position of formation of the sets of the first magnet and the first coil (the set of the magnet M1A and the coil C1A and the set of the magnet M1B and the coil C1B) that pivots the substrate 4 with reference to the rolling axis Ar is not particular limited, but, as the optical unit 1 of the present embodiment, it is preferred that sets of the first magnet and the first coil are provided as substrate pivoting mechanisms 50 on both sides of the rolling axis Ar as viewed from the reflection direction D2. This is because the balance of the substrate 4 with reference to the rolling axis Ar becomes better. Note that the optical unit 1 of the present embodiment includes the sets of the first magnet and the first coil as the substrate pivoting mechanisms 50 on both sides of the rolling axis Ar in the Y-axis direction, but, alternatively, the optical unit 1 may include sets of the first magnet and the first coil as the substrate pivoting mechanisms 50 on both sides of the rolling axis Ar in the X-axis direction.

In the optical unit 1 of the present embodiment, the substrate pivoting mechanisms 50 include sets of the first magnet and the coil, the first magnets (the magnet M1A and magnet M1B) being fixed to the substrate 4, the coils (coil C1A and coil C1B) being fixed to positions on the periphery of the substrate 4 and opposite the first magnets. Such a configuration is preferred because, by disposing the magnets, not the coils, on the substrate 4 the pivoting unit including the substrate 4 can be made smaller and the wiring can be facilitated. Alternatively, the coils may be disposed on the substrate 4 and the magnets may be disposed on the periphery of the substrate 4.

In the optical unit 1 of the present embodiment, the reflector pivoting mechanisms 51 includes sets of a second magnet and a second coil, the second magnets (the magnet M2 and the magnet M3) being fixed to the reflector 2, the second coils (the coil C2 and coil C3) being fixed at positions on the periphery of the reflector 2 and opposite the second magnets. Such a configuration is preferred because by providing the magnets, not the coils, in the reflector 2, the pivoting unit including the reflector 2 can be made smaller and wiring can be facilitated by leading the wiring members along the back side of the reflector 2. Alternatively, the coils may be disposed on the reflector 2 and the magnets may be disposed on the periphery of the reflector 2.

In the optical unit 1 of the present embodiment, the lens unit 3 is disposed between the substrate 4 and the reflector 2 as described above, and it is preferred that the lens unit 3 be fixed to the substrate 4, that is, the lens unit 3 and the substrate 4 constitute a single pivoting unit. This is because by fixing the lens unit 3 to the substrate 4, the substrate 4 can be pivoted while the positional relationship between the lens unit 3 and the substrate 4 is maintained. Alternatively, the lens unit 3 may be fixed to the casing or the like so that the lens unit 3 and the substrate 4 do not pivot together.

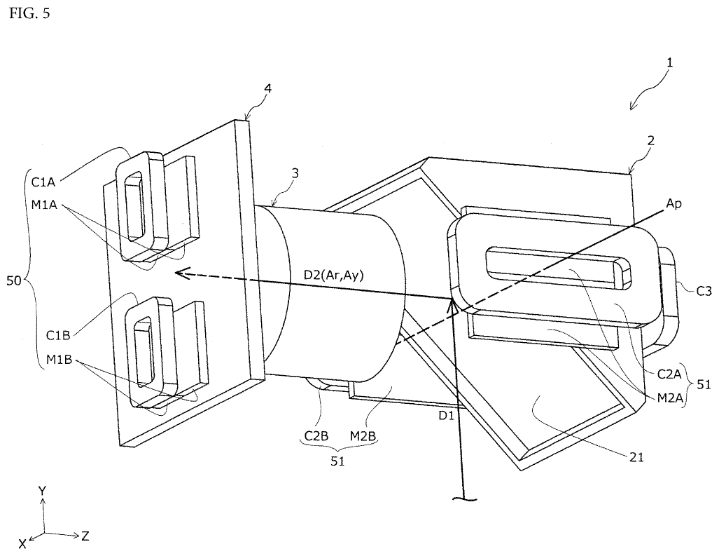

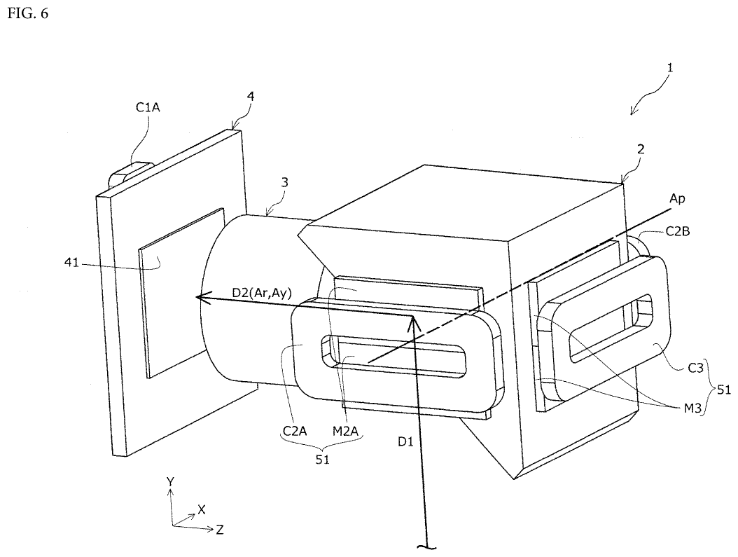

### Second Embodiment (FIGS. 5 and 6)

An optical unit 1 according to a second embodiment will now be described with reference to FIGS. 5 and 6. Here, FIG. 5 is a schematic perspective diagram of the optical unit 1 of the second embodiment corresponding to FIG. 3 illustrating the optical unit 1 of the first embodiment; and FIG. 6 is a schematic perspective diagram of the optical unit 1 of the second embodiment corresponding to FIG. 4 illustrating the optical unit 1 of the first embodiment. Note that the components common to those of the first embodiment are denoted by the same reference numerals, and detailed description thereof will be omitted. The optical unit 1 of the present embodiment has the same configuration as that of the optical unit 1 of the first embodiment, except for the configuration (number and arrangement) of the reflector pivoting mechanism 51 that pivots the reflector 2 with reference to the yawing axis Ay.

In the optical unit 1 of the first embodiment, the set of the magnet M2 and the coil C2 that pivots the reflector 2 with reference to the yawing axis Ay is disposed at a position overlapping the reflector 2 as viewed from the incident direction D1. In contrast, as illustrated in FIGS. 5 and 6, the optical unit 1 of the present embodiment includes sets of a second magnet and a second coil (the set of the magnet M2A and the coil C2A and the set of the magnet M2B and the coil C2B) as reflector pivoting mechanisms 51 that pivot the reflector with reference to the yawing axis Ay at positions overlapping the reflector 2 as viewed from the pitching axis direction (the X-axis direction). The optical unit 1 of the present embodiment has a configuration that is effective when there is no space to position the reflector pivoting mechanism 51 in a manner overlapping the reflector 2 as viewed from the incident direction.

Furthermore, as illustrated in FIGS. 5 and 6, the optical unit 1 of the present embodiment includes sets of the magnet M2 and the coil C2 (the set of the magnet M2A and the coil C2A and the set of the magnet M2B and the coil C2B) as the reflector pivoting mechanisms 51 that pivot the reflector 2 with reference to the yawing axis Ay on both sides of the reflector 2 along the pitching axis direction (the X-axis direction) as viewed from the incident direction D1. This configuration improves the balance of the reflector 2 with reference to the yawing axis Ay.

The present invention is not limited to the above-described embodiments and can be realized with various configurations without departing from the spirit of the present invention. For example, the technical features in the embodiments corresponding to the technical features in each of the aspects described in SUMMARY may be appropriately replaced or combined to solve some or all of the problems described above, or to achieve some or all of the effects described above. Furthermore, unless the technical features are described as essential in the present specification, it may be omitted as appropriate.

1. An optical unit comprising:
a substrate including an imaging element that captures a subject image by an incident light flux;
a reflector that reflects the incident light flux from an incident direction from outside in a reflection direction toward the imaging element;
a substrate pivoting mechanism including a set of a first magnet and a first coil and pivoting the substrate with reference to a rolling axis; and
a reflector pivoting mechanism including a set of a second magnet and a second coil and pivoting the reflector with reference to at least one of a yawing axis and a pitching axis.

2. The optical unit according to claim 1, wherein the reflector pivoting mechanism pivots the reflector with reference to both the yawing axis and the pitching axis.

3. The optical unit according to claim 1, wherein the set of the second magnet and the second coil pivoting the reflector with reference to the yawing axis is provided as the reflector pivoting mechanism at a position overlapping the reflector as viewed from the incident direction.

4. The optical unit according to claim 1, wherein the set of the second magnet and the second coil pivoting the reflector with reference to the yawing axis is provided as the reflector pivoting mechanism at a position overlapping the reflector as viewed from the pitching axis direction.

5. The optical unit according to claim 4, wherein sets of the second magnet and the second coil serving as the reflector pivoting mechanism to pivot the reflector with reference to the yawing axis are disposed on both sides of the reflector along the pitching axis direction as viewed from the incident direction.

6. The optical unit according to claim 1, wherein sets of the first magnet and the first coil serving as the substrate pivoting mechanism are disposed on both sides of a rolling axis as viewed from the reflection direction.

7. The optical unit according to claim 1, wherein the substrate pivoting mechanism includes a set of the first magnet and the first coil, the first magnet being fixed to the substrate, the first coil being fixed on a periphery of the substrate at a position opposite the first magnet.

8. The optical unit according to claim 1, wherein the reflector pivoting mechanism includes a set of the second magnet and the second coil, the second magnet being fixed to the reflector, the second coil being fixed on a periphery of the reflector at a position opposite the first magnet.

9. The optical unit according to claim 1, comprising:
a lens unit disposed between the substrate and the reflector, wherein
the lens unit is fixed to the substrate.
